(19) United States
(12) Patent Application Publication
(10) Pub. No.: US 2020/0213435 A1
(43) Pub. Date: Jul. 2, 2020

(54) Mobile phone holding heating device

(71) Applicant: Jian'er Chai, Tianjin City (CN)

(72) Inventor: Jian'er Chai, Tianjin City (CN)

(21) Appl. No.: 16/814,966

(22) Filed: Mar. 10, 2020

(30) Foreign Application Priority Data
Nov. 18, 2019 (CN) 2019111301556

(51) Int. Cl. H04M 1/17; B08B 1/00

(52) U.S. Cl. CPC H04M 1/17; B08B 1/006

(57) ABSTRACT

The invention discloses a heating device for holding and holding a mobile phone, which includes a warming block. The warming block is provided with a working cavity and a mobile phone cavity. The working cavity is provided with a temperature measuring mechanism. The water storage frame on the lower end wall of the working chamber is provided with a clamping mechanism on the upper side of the temperature measuring mechanism, the clamping mechanism includes a clamping block, and two clamping grooves are symmetrically provided on the rear wall of the working chamber. A moving mechanism is provided on the right side of the clamping mechanism, and the moving mechanism includes a contact shaft that is rotatably disposed on the rear wall of the working cavity. The device is easy to operate. After the mobile phone is clamped with two clamping blocks, the heating block is heated. It can heat the water in the water storage cavity. After heating to the moving temperature, it can stop heating excitedly to prevent the heating temperature from being too high and cause users to burn. When the heating is completed, the cleaning block will wipe the screen surface of the mobile phone in order. So that users do not have to manually wipe the screen of the phone.

### CROSS-REFERENCES TO RELATED APPLICATIONS

The present application claims priority from Chinese application No. 2019111301556 filed on Nov. 18, 2019 which is hereby incorporated by reference in its entirety.

### FIELD OF TECHNOLOGY

The invention relates to the field of mobile accessories, and in particular relates to a mobile phone holding heating device.

### TECHNICAL FIELD

Mobile phones, which belong to mobile terminals, are mobile phones that can be held in the hand. In the early days, because of their large size, they were commonly known as Big Brothers. At present, they have developed into the 4G era. The first mobile phone for civilian use in the world, “Martin Cooper” has since been called the “father of modern mobile phones”. Until now, mobile phones have become a very important tool in people's lives and have a variety of functions like the Swiss Army Knife. And bring people a good life experience. In winter, because of the cold weather, after using the phone for a long time, the hands may become very cold, and even temporarily lose consciousness, and it is easy to leave on the phone screen in winter. Fog, when using a mobile phone to play games, it may be too late to erase the fog or dirt on the phone screen.

### CONTENT OF THE INVENTION

The technical problem to be solved by the present invention is to provide a heating device for holding and holding a mobile phone, which overcomes the problems that the hand of the mobile phone is too cold in winter and the mobile phone screen is too late to be wiped when playing the mobile phone.

The present invention is achieved by the following technical solutions.

A heating device for holding and holding a mobile phone according to the present invention includes a warming block. The warming block is provided with a working cavity and a mobile phone cavity. The working cavity is provided with a temperature measuring mechanism. A water storage frame at the lower end wall of the working chamber. The water storage frame is provided with a water storage cavity, and the water storage cavity is filled with water. The left and right end walls of the water storage cavity are fixed with heating blocks, and the upper end of the water storage cavity. There are temperature measuring blocks penetrating up and down the wall. The temperature measuring block is provided with a temperature measuring cavity. There will be a negative pressure in the temperature measuring cavity. A horizontal plate is provided in the temperature measuring cavity to move up and down. A vertical rack is fixed on the end surface, a connecting rod is fixed on the rear end surface of the vertical rack, two rotating grooves are provided on the left and right end walls of the temperature measuring cavity, and a pin is fixed on the rear end surface of the rotating groove. A stopper is provided on the pin for rotation, and a torsion spring is provided between the stopper and the pin. Mercury is provided in the temperature measurement chamber. When the temperature rises, the horizontal plate can be moved upward. A stopper can restrict the horizontal plate from moving upwards;

A clamping mechanism is provided on the upper side of the temperature measuring mechanism, the clamping mechanism includes a clamping block, and two clamping grooves are symmetrically provided at the rear end wall of the working cavity. There are clamping rods, the clamping blocks are fixedly provided on the end surfaces close to the two clamping rods, and clamping springs are connected between the end surfaces of the two clamping rods that are far away and the end wall of the clamping groove, The two clamping blocks move left and right to clamp the collection;

A moving mechanism is provided on the right side of the clamping mechanism, and the moving mechanism includes a contact shaft that is rotatably disposed on the rear wall of the working cavity, and a rotation rod and a transmission gear are fixed on the contact shaft in order from back to front, The transmission gear meshes with the clamping lever on the right side, a telescopic groove is penetrating back and forth through the rear wall of the working cavity, and a telescopic block can be moved forward and backward in the telescopic groove. The telescopic block moves backward.

Preferably, the temperature measuring mechanism further includes a blocking bar, a rear wall of the working cavity is provided with a blocking bar groove, and a blocking bar is movably provided in the blocking bar groove. A telescopic spring is connected between the right end surface of the blocking rod and the right end wall of the blocking rod groove; a transmission cavity is arranged in the rear end wall of the working cavity; a rear end wall of the transmission cavity is provided with a rotation shaft and a rotation shaft A sector gear is fixedly fixed on the rear end wall of the transmission cavity, and a transmission slot is provided in the rear end of the transmission cavity. A movement frame is provided in the transmission groove to move left and right. A contact rod is fixed on the upper end surface of the movement frame. The moving frame can be engaged with the sector gear. Four fixing blocks are fixedly arranged on the rotation shaft. The fixing blocks are arranged on the front side of the sector gear. The rotation shaft is provided with a driving gear. There are four sliding grooves in the driving gear, and a moving block is provided in the sliding groove. A connecting spring is connected between an end surface of the moving block far from the rotating shaft and an end wall of the sliding groove far from the rotating shaft. The upward movement of the vertical rack can engage the driving gear move.

Preferably, the clamping mechanism further includes a transmission shaft rotatably disposed on the rear wall of the working cavity, and a first pulley and a contact gear are fixedly arranged on the transmission shaft in order from back to front, and the first belt A belt is wound on the wheel, and a driving shaft is provided on the rear wall of the working chamber. A second pulley and a friction wheel are provided on the driving shaft in turn from back to front. The transmission helical gear is provided with the driving shaft. Belt, a rear side wall of the working chamber is provided with a moving groove, and a horizontal bar is provided in the moving groove to be able to move left and right, a communication hole is provided through the vertical bar, and a vertical groove is provided at the rear wall of the working chamber. A detection block can be moved up and down in the vertical groove, and the connecting rod is fixedly provided on the right end surface of the detection block. A detection spring is connected between the upper end surface of the detection block and the upper end wall of the vertical groove. A switch is fixed at the lower end wall of the tank, and the detection block is moved downward to touch the switch to start the heating block to heat the water in the water storage cavity.

Preferably, the moving mechanism further includes a horizontal axis that is rotatably disposed on the rear wall of the working cavity. The horizontal axis is fixedly provided with a driven helical gear and a push rod in order from the left to the right. A driven shaft is provided for wall rotation, and a driven helical gear and a driven gear are fixed on the driven shaft in order from the back to the front. The driven gear can be engaged with the clamping lever on the right side. A gear meshes with the driven helical gear, a fixed rod is fixed on the upper end wall of the transmission cavity, a transmission rod is rotatably provided on the fixed rod, and a torsion spring is provided between the transmission rod and the fixed rod, A hollow block is fixed on the left side of the front end surface of the transmission rod. The front end surface of the hollow block is provided with a hollow slot opening forward. The hollow slot can be moved forward and backward in a rotary block. An adjustment spring is connected between the rear wall of the groove, and an abutment plate is provided on the front side of the transmission rod, an adjustment cavity with a rearward opening is provided on the rear end surface of the engagement plate, and an adjustment rod is fixed on the lower end wall of the adjustment cavity. The rotating rod is provided on the adjusting rod for rotation, and the lower end surface of the hollow rod is provided. A contact rod is fixed, a storage cavity is arranged in the hollow rod, a pin is fixed on the right end face of the storage cavity, a moving rod is provided on the pin to rotate, and a pop-up twist is provided between the moving rod and the pin. A spring, a cleaning block is fixed on the front side of the lower end surface of the moving rod.

Preferably, the driving gear can only drive the rotation shaft to rotate clockwise.

Preferably, the elastic force of the clamping spring is greater than the elastic force of the detection spring.

The beneficial effect of the invention is that the device is simple to operate. After the mobile phone is clamped with two clamping blocks, the heating block can heat the water in the water storage cavity. After heating to the moving temperature, the heating can be excited to stop heating to prevent If the heating temperature is too high, the user will be burned. After the heating is completed, the cleaning block will wipe the screen surface of the mobile phone one by one, so that the user does not need to manually wipe the screen of the mobile phone, which is very convenient. When the temperature is too low, the heating block will start heating again, very intimate.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those of ordinary skill in the art, other drawings can be obtained based on these drawings without paying creative labor.

FIG. 1 is a schematic front structural view of a whole cross section of a mobile phone holding heating device according to the present invention; FIG.

FIG. 2 is an enlarged schematic view of A in FIG. 1;

FIG. 3 is a schematic diagram in the direction of B-B in FIG. 1;

FIG. 4 is a schematic diagram in the direction of C-C in FIG. 1;

FIG. 5 is a schematic diagram of the D-D direction in FIG. 1;

FIG. 6 is a schematic diagram of an E-E direction in FIG. 1;

FIG. 7 is a schematic diagram of the rotation shaft installation in FIG. 2;

FIG. 8 is a schematic diagram of the F-F direction in FIG. 3;

FIG. 9 is a schematic diagram of the G-G direction in FIG. 8.

### DETAILED DESCRIPTION OF THE INVENTION

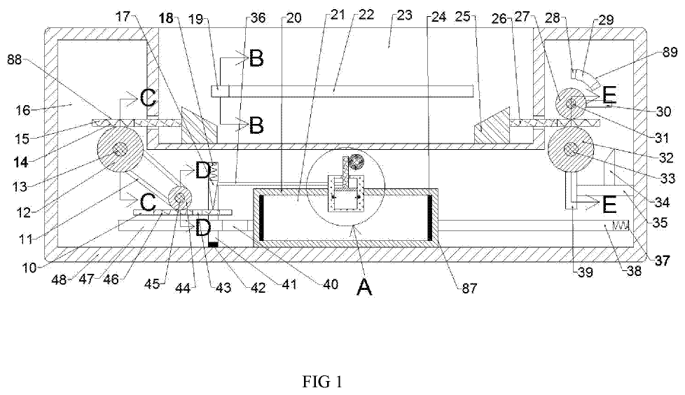

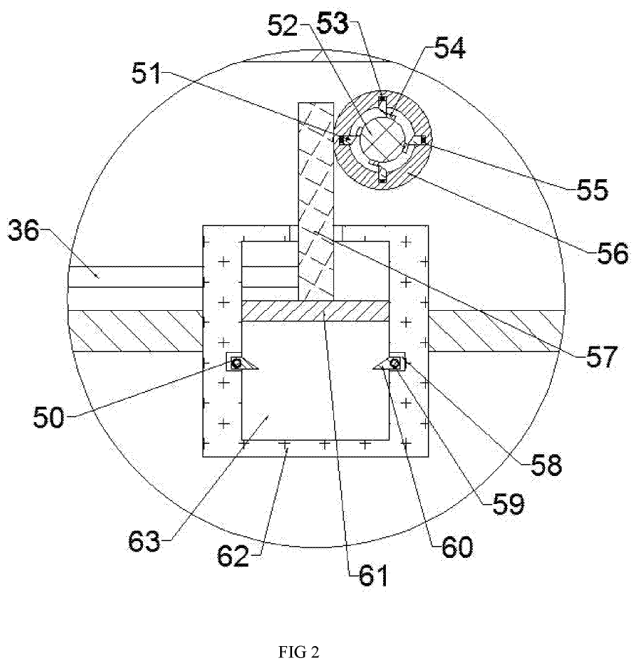

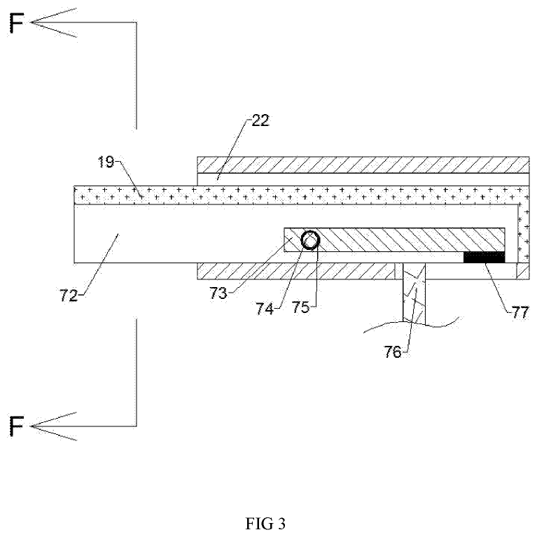

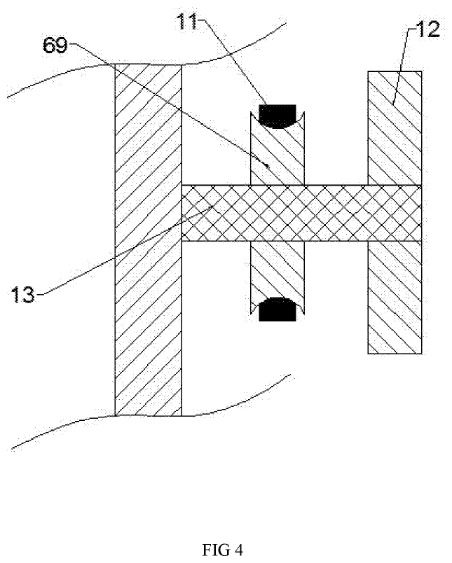

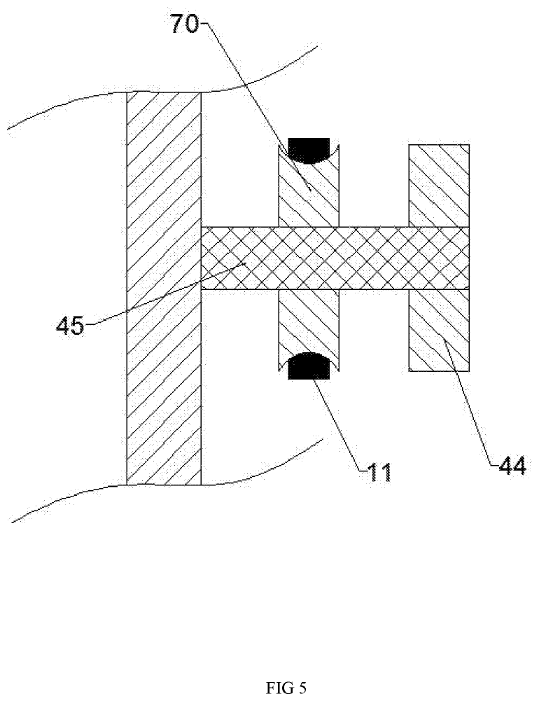

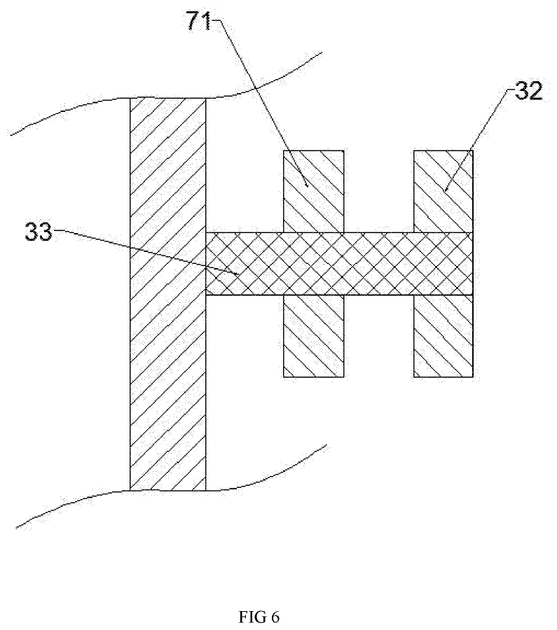

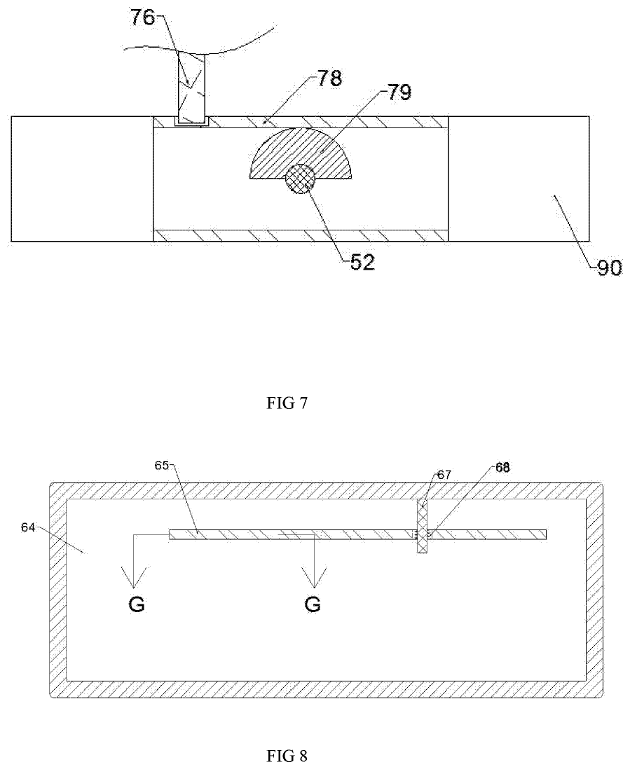

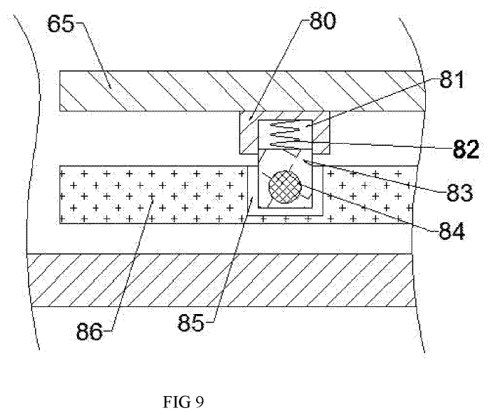

The present invention is described in detail below with reference to FIGS. 1-9. Among them, for convenience of description, the orientation described below is defined as follows: the up-down, left-right, front-back direction described below is consistent with the up-down, left-right, front-back direction of the projection relationship of FIG. 1 itself.

A schematic diagram of the mechanical mechanism of a mobile phone holding and heating device as shown in FIG. A temperature measuring mechanism 87 is provided. The temperature measuring mechanism 87 includes a water storage frame 20 fixed on the lower end wall of the working chamber 16. Water, the left and right end walls of the water storage cavity 21 are fixed with heating blocks 24, and the upper end wall of the water storage cavity 21 is provided with a temperature measurement block 62 penetrating up and down, and the temperature measurement block 62 is provided with a temperature measurement cavity 63. There will be a negative pressure in the temperature measuring cavity 63. A horizontal plate 61 is vertically moved in the temperature measuring cavity 63. A vertical rack 57 is fixed on the upper end face of the horizontal plate 61, and a rear end face of the vertical rack 57 is fixed. A connecting rod 36 is provided, and the left and right end walls of the temperature measurement chamber 63 are provided with two rotation grooves 58. A pin 59 is fixed on the rear end surface of the rotation groove 58, and a stopper 60 is provided on the pin 59 for rotation. A blocking torsion spring 50 is provided between the stopper 60 and the pin 59, and mercury is provided in the temperature measurement chamber 63. When the temperature rises, the horizontal plate 61 can be moved upward. The stopper 60 can The lateral plate 61 made of moved upward;

A clamping mechanism 88 is provided on the upper side of the temperature measuring mechanism 87. The clamping mechanism 88 includes a clamping block 25. Two rear clamping walls 15 of the working chamber 16 are symmetrically provided with two clamping grooves 15. A clamping rod 26 is movably provided in the slot 15, and the clamping blocks 25 are fixedly arranged on the end surfaces close to the two clamping rods 26. A clamping spring 14 is connected between the end walls of the groove 15, and the two clamping blocks 25 can be moved to clamp the collection;

A moving mechanism 89 is provided on the right side of the clamping mechanism 88, and the moving mechanism 89 includes a contact shaft 31 rotatably disposed on the rear wall of the working cavity 16, and the contact shaft 31 is fixedly arranged in order from back to front. The rotating rod 30 is engaged with a transmission gear 27 which meshes with the clamping lever 26 on the right side. A rear end wall of the working cavity 16 is provided with a telescopic groove 28 which can be moved forward and backward in the telescopic groove 28. There is a telescopic block 29, and the rotation lever 30 can rotate to push the telescopic block 29 to move backward.

Beneficially, the temperature measuring mechanism 87 is described in detail. The temperature measuring mechanism 87 further includes a blocking lever 38. A rear end wall of the working chamber 16 is provided with a blocking lever groove 47. The blocking lever groove 47 can be left and right inside. A stopper bar 38 is provided for movement, and a communication port 40 is vertically penetrated on the stopper bar 38. A telescopic spring 37 is connected between the right end face of the stopper bar 38 and the right end wall of the stopper slot 47. A transmission cavity 64 is provided in the end wall. A rear end wall of the transmission cavity 64 is provided with a rotation shaft 52. A fan gear 79 is fixed on the rotation shaft 52. A transmission groove 90 is provided on the rear wall of the transmission cavity 64. A moving frame 78 is movably provided in the transmission groove 90. The upper end surface of the moving frame 78 is fixed with a contact rod 76. The sector gear 79 can be engaged with the movement frame 78 and the sector gear 79. Four fixed blocks 54 are fixed on the rotating shaft 52, and the fixed blocks 54 are provided on the front side of the sector gear 79. A driving gear 56 is provided on the rotating shaft 52, and the driving gear 56 is provided inside. There are four sliding grooves 55, and a moving block 51 is provided in the sliding groove 55. An end surface of the moving block 51 far from the rotating shaft 52 and the sliding block The end wall 55 away from the rotational shaft 52 is connected to a spring connection 53, the vertical upward movement of the rack 57 can be engaged to drive said driven gear 56 rotates.

Beneficially, the clamping mechanism 88 is described in detail. The clamping mechanism 88 further includes a transmission shaft 13 rotatably disposed on the rear wall of the working chamber 16, and the transmission shaft 13 is sequentially fixed from rear to front. A first pulley 69 and a contact gear 12 are provided. A belt 11 is wound around the first pulley 69. A rear end wall of the working chamber 16 is provided with a driving shaft 45, and the driving shaft 45 runs from rear to forward. A second pulley 70 and a friction wheel 44 are provided in turn. The transmission helical gear 71 is wound with the belt 11. A rear end wall of the working chamber 16 is provided with a moving groove 10. A cross bar 46 is provided for movement, and a communication hole 43 is penetrated up and down through the cross bar 46. A vertical groove 41 is provided at the rear wall of the working cavity 16, and a detection block 17 is vertically movable in the vertical groove 41. The connecting rod 36 is fixed on the right end surface of the detection block 17, a detection spring 18 is connected between the upper end surface of the detection block 17 and the upper end wall of the vertical groove 41, and a switch 42 is fixed on the lower end wall of the vertical groove 41 The detection block 17 moves downward and touches the switch 42 to start the heating block 24 to heat the water in the water storage chamber 21.

Beneficially, the moving mechanism 89 is described in detail. The moving mechanism 89 further includes a horizontal axis 35 which is rotatably disposed on the rear wall of the working cavity 16, and the horizontal axis 35 is fixedly arranged in order from left to right. The driven helical gear 39 and the push rod 34 are provided with a driven shaft 33 at the rear end wall of the working chamber 16, and a driven helical gear 71 and a driven gear 32 are fixed on the driven shaft 33 in order from back to front. The driven gear 32 can mesh with the clamping lever 26 on the right side, the transmission helical gear 71 meshes with the driven helical gear 39, and a fixed rod 67 is fixed on the upper end wall of the transmission cavity 64. A transmission rod 65 is rotatably provided on the fixed rod 67. A torsion spring 68 is provided between the transmission rod 65 and the fixed rod 67. A hollow block 80 is fixed on the left side of the front end of the transmission rod 65. The front end surface of 80 is provided with a hollow slot 81 opening forward, and a rotary block 83 is movably provided in the hollow slot 81. An adjustment spring 82 is connected between the rear end surface of the rotary block 83 and the rear end wall of the hollow slot 81. An abutting plate 86 is provided on the front side of the transmission rod 65, and an adjusting cavity 85 with a rearward opening is provided on the rear end surface of the abutting plate 86. The lower end wall of the whole cavity 85 is fixed with an adjusting rod 84. The adjusting rod 84 is rotatably provided with the rotating block 83. The lower end surface of the hollow rod 19 is fixed with a contact rod 76. The hollow rod 19 is provided with a storage therein. A cavity 72 is fixedly provided with a pin 74 on the right end face of the storage cavity 72. A moving rod 73 is rotatably provided on the pin 74, and an ejection torsion spring 75 is provided between the moving rod 73 and the pin 74. 73 A cleaning block 77 is fixed on the front side of the lower end surface.

Beneficially, the driving gear 56 can only drive the rotating shaft 52 to rotate clockwise.

Advantageously, the elastic force of the clamping spring 14 is greater than the elastic force of the detection spring 18.

In the initial state, the clamping spring 14, the expansion spring 37, the blocking torsion spring 50, the connection spring 53, the torsion spring 68, and the adjustment spring 82 are in a normal state, and the detection spring 18 The ejection torsion spring 75 is in a compressed state, the cross bar 46 is located on the left side in the moving groove 10, the blocking lever 38 is located on the right side of the blocking groove 47, and the moving lever 73 is in a horizontal state.

The sequence of mechanical actions of the entire device:

(1) Put the mobile phone into the cavity 23 of the mobile phone. The mobile phone pushes the two clamping blocks 25 away from each other. The left clamping block 25 moves the left clamping lever 26 to the left and the left clamping lever 26 to the left. The movement and meshing drive the contact gear 12 to rotate. The contact gear 12 drives the first pulley 69 to rotate through the transmission shaft 13. The first pulley 69 frictionally drives the second pulley 70 to rotate through the belt 11 and the second pulley 70 to drive the shaft 45. The friction wheel 44 is driven to rotate, and the friction wheel 44 is engaged to drive the cross bar 46 to move to the right.

(2) The right clamping block 25 drives the clamping lever 26 to move to the right, the clamping lever 26 moves to the right, the meshing drives the driven gear 32 to rotate, and the driven gear 32 drives the transmission helical gear 71 to rotate through the driven shaft 33. The driven helical gear 71 meshes and drives the driven helical gear 39 to rotate. The driven helical gear 39 drives the push rod 34 to rotate through the horizontal shaft 35. When the push rod 34 rotates to the lower side, the push lever 38 moves to the left, and the push lever 38 moves to the left. The movement, the detection spring 18 pushes the detection block 17 downward, the detection block 17 passes through the communication hole 43 and the communication port 40, and the switch 42 is pressed, the heating block 24 is activated to heat the water in the water storage chamber 21, and the detection block 17 passes The connecting rod 36 drives the vertical rack 57 to move downward, and the horizontal plate 61 moves downward along with the vertical rack 57.

(3) The right clamping lever 26 moves to the right, and the meshing drives the transmission gear 27 to rotate. The transmission gear 27 rotates the rotation lever 30 through the contact shaft 31. The rotation lever 30 rotates, and the telescopic block 29 is pressed backward, and the telescopic block 29 is rearward. Move, push the transmission rod 65 to rotate around the fixed rod 67, the transmission rod 65 drives the rotation block 83 to move forward through the hollow block 80, the rotation block 83 drives the fitting plate 86 to move forward, and the fitting plate 86 pushes the hollow rod 19 to move forward, hollow The rod 19 drives the moving rod 73 forward through the pin 74. After the moving rod 73 moves out of the horizontal groove 22, the ejection torsion spring 75 pushes the moving rod 73 to rotate, so that the cleaning block 77 can contact the screen of the mobile phone.

(4) When the water temperature in the water storage chamber 21 gradually rises, the horizontal plate 61 moves upward, and the stopper 60 blocks the horizontal plate 61 and does not allow the horizontal plate 61 to move upward. At this time, the detection block 17 has not left the switch 42. When the water temperature When it exceeds forty degrees Celsius, the horizontal plate 61 moves upward, driving the detection block 17 away from the switch 42, and the heating block 24 stops heating the water temperature.

(5) When the vertical rack 57 moves upward, the meshing drives the gear 56 to rotate, the gear 56 drives the rotating shaft 52 to rotate, the rotating shaft 52 drives the sector gear 79 to rotate, and the sector gear 79 meshes to drive the moving frame 78 to move left and right, and the moving frame 78 The contact rod 76 drives the hollow rod 19 to move left and right, and the cleaning block 77 moves left and right to wipe away the surface sink and fog of the screen of the mobile phone. After the heating is stopped, the vertical rack 57 will not continue to rise, and the cleaning block 77 will not continue to move. When the water temperature drops, the vertical rack 57 moves downward, the rotating shaft 52 does not rotate, and the cleaning block 77 does not continue to move left and right.

(6) After the mobile phone is taken away from the mobile phone cavity 23, the two clamping blocks 25 approach, the cross bar 46 moves to the left, the stop lever 38 moves to the right, the detection block 17 moves upward, the telescopic block 29 moves forward, and the hollow rod 19 is moved backward, and the lower end face of the transverse groove 22 causes the moving lever 73 to rotate and return to the initial state.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. A mobile phone holding heating device, comprising a heating block, characterized in that: the heating block is provided with a working cavity and a mobile phone cavity, and a temperature measuring mechanism is provided in the working cavity, and the temperature measuring mechanism includes a fixed A water storage frame is provided at the lower end wall of the working cavity, and the water storage frame is provided with a water storage cavity. The water storage cavity is filled with water. The left and right end walls of the water storage cavity are fixed with heating blocks. The upper end wall of the water cavity is provided with a temperature measuring block up and down. The temperature measuring block is provided with a temperature measuring cavity. There will be a negative pressure in the temperature measuring cavity. A horizontal plate is provided in the temperature measuring cavity to move up and down. A vertical rack is fixed on the end surface of the horizontal plate, a connecting rod is fixed on the rear end surface of the vertical rack, two rotating grooves are provided on the left and right end walls of the temperature measuring cavity, and a pin is fixed on the rear end surface of the rotating groove. A stopper is provided on the pin for rotation, a blocking torsion spring is provided between the stopper and the pin, and mercury is provided in the temperature measurement chamber. When the temperature rises, the horizontal plate can be driven to move upward. The stopper can restrict the upward movement of the horizontal plate; a clamping mechanism is provided on the upper side of the temperature measuring mechanism, and the clamping mechanism includes The clamping block is provided with two clamping grooves symmetrically on the rear wall of the working cavity. The clamping groove can be moved left and right to have clamping rods. A clamping spring, a clamping spring is connected between an end surface away from the two clamping rods and an end wall of the clamping groove, and the two clamping blocks are moved left and right to clamp the collection; A moving mechanism is provided on the right side of the mechanism. The moving mechanism includes a contact shaft that is rotatably disposed on the rear wall of the working cavity. The contact shaft is fixedly provided with a rotation rod and a transmission gear in order from the back to the front. Engaged with the clamping lever on the right side, a telescoping slot is provided through the rear wall of the working cavity in the front and back, and a telescoping block can be moved forward and backward in the telescoping slot. After moving.

2. A mobile phone holding heating device according to claim 1, wherein the temperature measuring mechanism further comprises a blocking bar, and a rear wall of the working cavity is provided with a blocking bar groove, A blocking lever can be moved left and right, and a communication port is provided through the blocking lever. A telescopic spring is connected between the right end surface of the blocking lever and the right end wall of the blocking lever groove. A transmission cavity, a rear end wall of the transmission cavity is provided with a rotation shaft, and a sector gear is fixed on the rotation shaft; a rear end wall of the transmission cavity is provided with a transmission slot; A contact rod is fixed on the upper end surface of the moving frame, the sector gear can be engaged with the moving frame and the sector gear, and four fixed blocks are fixed on the rotating shaft. On the front side of the sector gear, a driving gear is provided on the rotating shaft for rotation, and the driving gear is provided with four sliding grooves, and a moving block is arranged in the sliding groove, and the end face of the moving block is far from the rotating shaft. A connection is connected with an end wall of the slide groove away from the rotating shaft. Connected with a spring, the vertical rack can move upward to engage and drive the driving gear to rotate.

3. A mobile phone holding and heating device according to claim 2, wherein the clamping mechanism further comprises a transmission shaft rotatably disposed on a rear wall of the working chamber, and the transmission shaft is from rear to bottom A first pulley and a contact gear are fixedly arranged in front, and a belt is wound on the first pulley. A driving shaft is provided on the rear wall of the working chamber, and a driving shaft is provided on the driving shaft. A second pulley and a friction wheel, the transmission helical gear is wound with the belt, a rear end wall of the working cavity is provided with a moving slot, and a horizontal bar can be moved in the moving slot to the left and right. A communication hole is provided through the upper and lower sides, and a vertical groove is provided at the rear wall of the working cavity. A detection block can be moved up and down in the vertical groove. The right end of the detection block is fixedly provided with the connecting rod. A detection spring is connected between the upper end surface and the upper end wall of the vertical groove. A switch is fixed on the lower end wall of the vertical groove. The detection block moves downward to touch the switch to start the heating block to the water storage cavity. Water is heated.

4. A mobile phone holding and heating device according to claim 3, wherein the moving mechanism further comprises a horizontal axis rotatably disposed on a rear wall of the working cavity, and the horizontal axis is from left to right A driven helical gear and a push rod are fixedly arranged in order, a driven shaft is rotatably provided on the rear wall of the working cavity, and a driven helical gear and a driven gear are fixed on the driven shaft in order from back to front. The driven gear can mesh with the clamping lever on the right side, the transmission helical gear meshes with the driven helical gear, a fixed rod is fixed on the upper end wall of the transmission cavity, and a driving rod is provided on the fixed rod in rotation A torsion spring is provided between the transmission rod and the fixed rod; a hollow block is fixedly located on the left side of the front end surface of the transmission rod; A turning block can be moved forward and backward. An adjusting spring is connected between the rear end surface of the turning block and the rear end wall of the hollow groove. Adjustment cavity, the lower end wall of the adjustment cavity is fixed with an adjustment rod, The adjusting block is provided with the rotating block for rotation, and the lower end of the hollow rod is fixedly provided with a contact rod. The hollow rod is provided with a receiving cavity therein. A moving rod is provided, an ejection torsion spring is provided between the moving rod and the pin, and a cleaning block is fixed on the front side of the lower end surface of the moving rod.

5. The mobile phone holding heating device according to claim 2, wherein the driving gear can only drive the rotation shaft to rotate clockwise.

6. The mobile phone holding and heating device according to claim 3, wherein the elastic force of the clamping spring is greater than the elastic force of the detecting spring.
